(19) United States
(12) Patent Application Publication
(10) Pub. No.: US 2025/0296329 A1
(43) Pub. Date: Sep. 25, 2025

(54) LIQUID DISCHARGE HEAD AND LIQUID DISCHARGE APPARATUS

(71) Applicant: Atsushi TAKEUCHI, Kanagawa (JP)

(72) Inventor: Atsushi TAKEUCHI, Kanagawa (JP)

(21) Appl. No.: 19/078,571

(22) Filed: Mar. 13, 2025

(30) Foreign Application Priority Data
Mar. 19, 2024 (JP) 2024-043746

(51) Int. Cl. B41J 2/14

(52) U.S. Cl. CPC B41J 2/14233; B41J 2002/14491

(57) ABSTRACT

A liquid discharge head includes a nozzle layer, a pressure chamber layer, a fluid resistor layer, and a channel layer. The nozzle layer has nozzles arrayed in a first direction, orthogonal to a discharge direction. The pressure chamber layer has a pressure chamber. The fluid resistor layer has a first fluid resistor and a second fluid resistor. The channel layer has a first channel, a second channel, and a partition partitioning the first channel and the second channel. The first fluid resistor is elongated in a second direction orthogonal to each of the first direction and the discharge direction in an area overlapping with the first channel of the pressure chamber in a plan of the pressure chamber layer. The second fluid resistor is elongated in the second direction in an area overlapping the second channel of the pressure chamber in the plan.

### CROSS-REFERENCE TO RELATED APPLICATION

This patent application is based on and claims priority pursuant to 35 U.S.C. § 119 (a) to Japanese Patent Application No. 2024-043746, filed on Mar. 19, 2024, in the Japan Patent Office, the entire disclosure of which is hereby incorporated by reference herein.

### BACKGROUND

### Technical Field

Embodiments of the present disclosure relate to a liquid discharge head and a liquid discharge apparatus.

### Related Art

A liquid discharge head is known that includes a nozzle layer having nozzles, a pressure chamber layer having pressure chambers communicating with the nozzles, a fluid resistor layer having first fluid resistors communicating with the respective pressure chambers and second fluid resistors communicating with the respective pressure chambers, and a channel layer having first channels communicating with the respective first fluid resistors, second channels communicating with the respective second fluid resistors, and partitions partitioning the respective first channels and the respective second channels.

In another known liquid discharge head, a pressure chamber has a circular shape when viewed from a direction in which liquid is discharged, a partition passes through the center of the circular pressure chamber, and first fluid resistors and second fluid resistors each have a round hole shape.

### SUMMARY

In an embodiment of the present disclosure, a liquid discharge head includes a nozzle layer, a pressure chamber layer, a fluid resistor layer, and a channel layer. The nozzle layer has multiple nozzles arrayed in a first direction, to discharge a liquid in a discharge direction orthogonal to the first direction. The pressure chamber layer over the nozzle layer in the discharge direction, has a pressure chamber communicating with the multiple nozzles. The fluid resistor layer over the pressure chamber layer in the discharge direction, has a first fluid resistor and a second fluid resistor, each communicating with the pressure chamber. The channel layer over the fluid resistor layer in the discharge direction, has a first channel communicating with the first fluid resistor, a second channel communicating with the second fluid resistor, and a partition partitioning the first channel and the second channel. The first fluid resistor is elongated in a second direction orthogonal to each of the first direction and the discharge direction in an area overlapping with the first channel of the pressure chamber in a plan of the pressure chamber layer. The second fluid resistor is elongated in the second direction in an area overlapping the second channel of the pressure chamber in the plan.

In another embodiment of the present disclosure, a liquid discharge head includes a nozzle layer, a pressure chamber layer, a fluid resistor layer, and a channel layer. The nozzle layer has multiple nozzles arrayed in a first direction, to discharge a liquid in a discharge direction orthogonal to the first direction. The pressure chamber layer over the nozzle layer in the discharge direction, has a pressure chamber communicating with the multiple nozzles. The fluid resistor layer over the pressure chamber layer in the discharge direction, has multiple first fluid resistors communicating with the pressure chamber and multiple second fluid resistors communicating with the pressure chamber. The channel layer over the fluid resistor layer in the discharge direction, has a first channel communicating with the first fluid resistor, a second channel communicating with the second fluid resistor and a partition partitioning the first channel and the second channel. The multiple first fluid resistors are arrayed in the second direction in an area overlapping the first channel of the pressure chamber in the plan. The multiple second fluid resistors are arrayed in the second direction in an area overlapping the second channel of the pressure chamber in the plan.

In still another embodiment of the present disclosure, a liquid discharge apparatus includes the liquid discharge head.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic cross-sectional view of a liquid discharge head of a nozzle plate vibration method;

FIG. 2 is a cross-sectional view of the liquid discharge head of FIG. 1, taken along line A-A′ of FIG. 1;

FIG. 3 is a cross-sectional view of the liquid discharge head of FIG. 1, taken along line B-B′ of FIG. 1;

FIG. 4 is a cross-sectional view of the liquid discharge head of FIG. 1, taken along line D-D′ of FIG. 2;

FIG. 5 is a diagram illustrating fluid resistors according to a comparative example;

FIG. 6 is a cross-sectional view of a liquid discharge head in which a fluid resistor substrate and a pressure chamber substrate are bonded together in a manner misaligned with each other, according to a comparative example;

FIGS. 7A and 7B are diagrams each illustrating fluid resistors and the surroundings thereof;

FIG. 8 is a diagram illustrating fluid resistors and the surroundings thereof, according to a first modification;

FIGS. 9A and 9B are diagrams each illustrating fluid resistors and the surroundings thereof according to a second modification;

FIG. 10 is a cross-sectional view of a liquid discharge head according to a third modification;

FIG. 11 is a schematic cross-sectional view of a liquid discharge head according to a fourth modification;

FIG. 12 is a schematic cross-sectional view of the liquid discharge head of the fourth modification, taken along a line D-D′ in FIG. 2.

FIG. 13 is a schematic cross-sectional view of a liquid discharge head in which dampers are disposed on both sides of a sealing substrate;

FIG. 14 is a schematic diagram illustrating a printer according to embodiments of the present disclosure;

FIG. 15 is a plan view of a head unit of the printer of FIG. 14;

FIG. 16 is a plan view of a part of another printer;

FIG. 17 is a side view of a part of the printer of FIG. 16;

FIG. 18 is a plan view of a part of a liquid discharge unit; and

FIG. 19 is a front view of the liquid discharge unit of FIG. 18.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of a liquid discharge head and a liquid discharge apparatus, according to embodiments of the present disclosure, with reference to the accompanying drawings. It is to be understood that those skilled in the art can easily modify and change the present disclosure within the scope of the appended claims to form other embodiments, and these modifications and changes are included in the scope of the appended claims. The following embodiments are illustrative and do not limit the scope of the appended claims.

The liquid discharge head according to the present embodiment is a liquid discharge head of a nozzle plate vibration method. The liquid discharge head includes a nozzle plate having nozzles and actuators disposed on the nozzle plate, and pressure chambers. The liquid discharge head causes the actuators to vary the pressure in the pressure chambers to discharge liquid from the nozzles, respectively. The liquid discharge head of the nozzle plate vibration method can discharge droplets with a smaller power than a typical liquid discharge head of an unimorph-type piezoelectric head, which vibrates a face of the pressure chamber opposed to a wall (nozzle communication wall) having a communication opening communicating with the nozzle to discharge liquid. Thus, it is possible to achieve power saving of the actuator.

The increased density of the nozzles limits a space for laying out a wiring for voltage application. In such a case, it is difficult to install the wiring on the surface of a substrate. However, the wiring and a drive circuit can be installed on the substrate having the nozzles with high density. Typically, lead zirconate titanate (PZT) that has high piezoelectric properties is widely used as a material of a piezoelectric element employed as an actuator. However, when a piezoelectric film is formed on a substrate on which wiring and a driving circuit are formed, the temperature for forming and crystallizing the PZT needs to be equal to or greater than 600° C. Accordingly, when the PZT is used as the material of the piezoelectric element, the driving circuit and the wiring on the substrate cannot withstand the high temperature. For this reason, in a configuration in which wiring and a driving circuit are formed on a substrate, a piezoelectric material having a lower film forming temperature than the PZT is necessary as the piezoelectric material, and a material having lower piezoelectric properties than the PZT is necessarily selected. However, as described above, the liquid discharge head of the nozzle plate vibration method can discharge droplets with the smaller power than the typical unimorph-type piezoelectric head. For this reason, even when a piezoelectric material having the lower piezoelectric properties than that of PZT is used, the liquid discharge head of the nozzle plate vibration method can discharge droplets as desired. Accordingly, the liquid discharge head of the nozzle plate vibration method that uses the piezoelectric material such as a non-lead material, which has a low film formation and crystallization temperature but has the low piezoelectric properties, can discharge liquid droplets as desired. As a result, the wiring and the drive circuit can be installed on the substrate, and the nozzles can be arranged with high density.

Further, the liquid discharge head of the nozzle plate vibration method can reduce the volume of the liquid chamber. As a result, the head can be downsized.

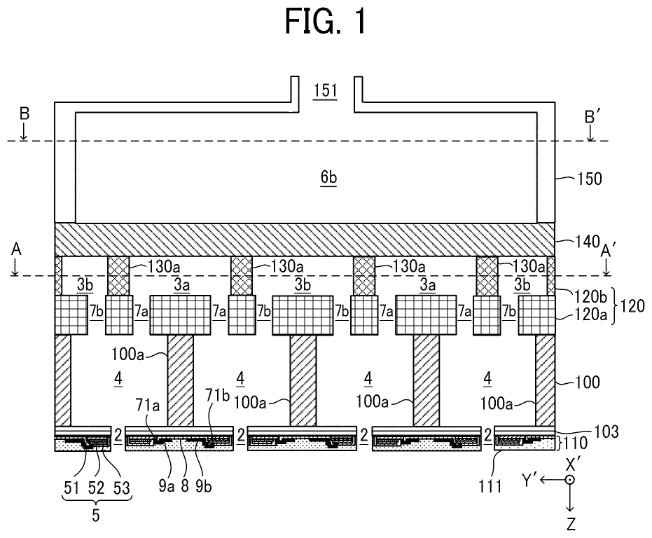

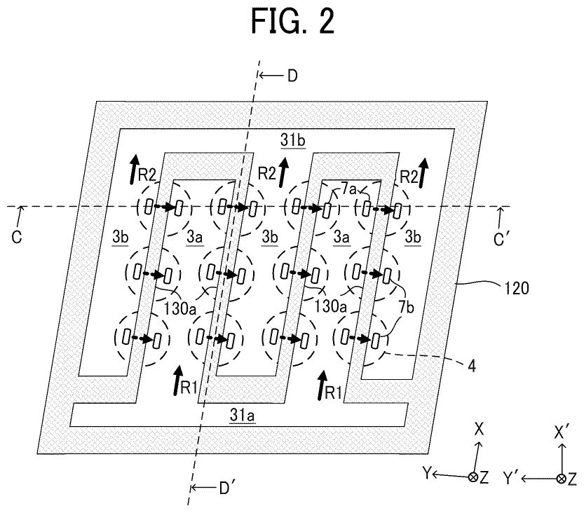

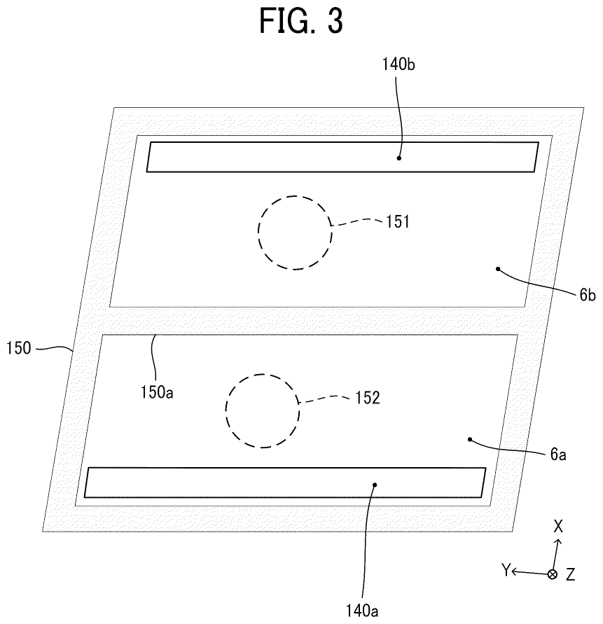

FIG. 1 is a schematic cross-sectional view of a liquid discharge head 1 of the nozzle plate vibration method, according to an embodiment of the present disclosure. FIG. 2 is a cross-sectional view of the liquid discharge head 1 taken along line A-A′ of FIG. 1. FIG. 3 is a cross-sectional view of the liquid discharge head 1 taken along line B-B′ of FIG. 1.

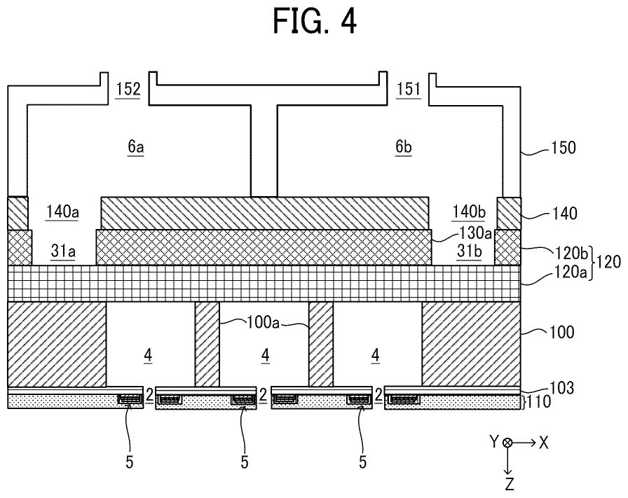

FIG. 4 is a cross-sectional view of the liquid discharge head 1 taken along line D-D′ of FIG. 2. FIG. 1 is a cross-sectional view of the liquid discharge head 1 taken along line C-C of FIG. 2.

In the following description, a direction in which liquid is discharged is referred to as Z direction, a direction in which a channel partition 130a, which serves as a partition to partition a supply channel 3b of a fluid resistor substrate and a discharge channel 3b, extends is referred to as X direction, and a direction orthogonal to both the Z direction in which liquid is discharged and the X direction in which the channel partition 130a extends is referred to as Y direction. In addition, a direction in which a common supply channel 31a extends is Y′ direction, and a direction orthogonal to both the X direction in which liquid is discharged and the Y′ direction in which the common supply channel 31a extends is X′ direction.

The liquid discharge head 1 includes a nozzle plate 110 as a nozzle layer, a pressure chamber substrate 100 as a pressure chamber layer, a fluid resistor substrate 120, a sealing substrate 140, and a frame 150.

The nozzle plate 110 is a thin film and includes multiple nozzles 2 for discharging liquid, piezoelectric elements 5 as annular actuators, which serve as electromechanical transducer elements, disposed around the respective nozzles 2. The nozzle plate 110 includes a nozzle forming portion (film) 111, which covers the piezoelectric elements 5.

In the present embodiment, the nozzles 2 are arranged in a two-dimensional direction. Specifically, as illustrated in FIG. 2, multiple nozzle arrays in which the nozzles 2 are linearly arranged along the Y′ direction, i.e., the left-right direction in FIG. 2, are arranged in the X direction, i.e., the vertical direction in FIG. 2. FIG. 2 illustrates, for simplicity of explanation, an example in which three nozzle arrays each having five nozzles 2 arranged linearly, are arranged. As illustrated in FIG. 2, the nozzles 2 in each of the nozzle arrays are arranged in the left-right direction such that the positions of the nozzles 2 that face each other are shifted from each other in the Y direction, which is the direction in which the nozzle arrays are arranged. Accordingly, the X direction in which the nozzles 2 are adjacent to each other in each of the nozzle arrays are arranged is not orthogonal to the Y′ direction, but inclined with respect to the Y′ direction.

A liquid-repellent film may be formed on a nozzle face of the nozzle forming portion 111. When the liquid is consecutively discharged, a mist that is generated simultaneously with the discharge of the liquid adheres to the nozzle face. When a large amount of mist adheres to the nozzle face, the liquid discharged from the nozzles 2 may be affected by the liquid adhering to the nozzle face and may be shifted from desired landing positions. The liquid-repellent film on the nozzle face prevents the liquid from adhering to the nozzle face. Accordingly, the liquid discharged from the nozzles 2 is not affected by the liquid adhering to the nozzle face.

The piezoelectric element 5 of the nozzle plate 110 includes a first electrode 51, a piezoelectric body 52, and a second electrode 53. The first electrode 51 may be referred to as a lower electrode, and the second electrode 53 may be referred to as an upper electrode.

The piezoelectric element 5 is covered with an insulation film 8. The insulation film 8 has a hole-shaped first contact 71a through which the first electrode 51 and a first lead wiring 9a are electrically connected, and a hole-shaped second contact 71b through which the second electrode 53 and a second lead wiring 9b are electrically connected.

The first lead wiring 9a is formed on a face of the insulation film 8 of the nozzle plate 110 opposite a vibration film 103 and electrically connected to the first electrode 51 of the piezoelectric element 5 via the first contact 71a. The second lead wiring 9b is also formed on the face of the insulation film 8 of the nozzle plate 110 opposite the vibration film 103 and electrically connected to the second electrode 53 of the piezoelectric element 5 via the second contact 71b. The first lead wiring 9a and the second lead wiring 9b are electrically connected to, for example, wiring formed on a face of the pressure chamber substrate 100 facing the nozzle 2, and are electrically connected to electrical connection pads formed at an end of the liquid discharge head 1. A drive waveform that is applied to the piezoelectric element 5 from the outside is input to the electrical connection pad.

The liquid that is filled in the liquid discharge head 1 enters the nozzles 2 and forms meniscuses in the nozzles 2. A predetermined drive waveform (voltage) is applied to the first electrode 51 and the second electrode 53 of the piezoelectric element 5. By so doing, the piezoelectric body 52 vibrates to vibrate the vibration film 103. As the vibration film 103 vibrates, the pressure of the liquid in the pressure chamber changes, and the liquid is discharged from the nozzle 2.

The first electrode 51 and the second electrode 53 are preferably made of a metal having low electrical resistivity and low reactivity, such as Ir or Mo. When the drive circuit that drives the piezoelectric element 5 and the wiring that connects the drive circuit and the piezoelectric element 5 are built in the pressure chamber substrate 100 to increase the density of the nozzles 2 as in the present embodiment, the piezoelectric material that constitutes the piezoelectric body 52 preferably has a film formation temperature of 450° C. or less so not to damage the drive circuit and the wiring. Examples of the piezoelectric material that has the film forming temperature of 450° C. or less, include scandium aluminum nitride (ScAlN) having a higher piezoelectric constant than aluminum nitride (AlN).

ScAlN as the piezoelectric material provides the following advantages. The piezoelectric body 52 in which a crystal orientation is aligned can enhance the piezoelectric property thereof. An orientation control layer between the vibration film 103 and the first electrode 51 is formed in order to control the crystal orientation. When the piezoelectric material of the piezoelectric body 52 is ScAlN, ScAlN as the orientation control layer can bring a lattice constant of the first electrode 51 made of Mo closer to that of ScAlN. As a result, the crystal orientation of the piezoelectric body 52 is aligned to enhance the piezoelectric property.

The pressure chamber substrate 100 has multiple pressure chambers 4, which may be referred to as individual liquid chambers or pressurization chambers. The multiple pressure chambers 4 communicate with the respective nozzles 2. The multiple pressure chambers 4 are partitioned by respective partitions 100a as first partitions.

The pressure chamber substrate 100 is a silicon substrate, and the vibration film 103 is formed on the face of the pressure chamber substrate 100 closer to the nozzle plate 110. The multiple pressure chambers 4 were formed by applying a micro-electromechanical systems (MEMS) process to the pressure chamber substrate 100 as the silicon substrate.

The vibration film 103 may be made of a material having at least the electrical insulation property, such as silicon dioxide (SiO₂), silicon nitride (SIN), metallic oxides, and resins. However, the material for the vibration film 103 preferably has a low Young's modulus to increase the displacement amount, and in consideration of the difference in linear expansion coefficient between the material and the pressure chamber substrate 100, SiO2 having a relatively small difference in linear expansion coefficient is most preferable as the material of the vibration film 103.

Each of the pressure chambers 4 has a circular shape when viewed from the Z direction, and the depth of each of the pressure chambers 4 (the length of the pressure chamber 4 in the Z direction, i.e., the thickness of the pressure chamber substrate 100) is preferably 50 to 1000 μm. When the depth of the pressure chamber 4 is shallow, liquid flow is generated to the vicinity of the nozzle 2 when liquid circulates in the pressure chamber 4. Accordingly, the effect of liquid circulation such as prevention of ink drying in the nozzle 2, discharge of air bubbles, and prevention of ink sedimentation is enhanced. By contrast, if the depth of the pressure chamber 4 is too shallow, i.e., smaller than 50 μm, the pressure chamber substrate 100 is likely to be broken when the pressure chamber substrate 100 is produced.

The fluid resistor substrate 120 is bonded to a face of the pressure chamber substrate 100 opposite the nozzle 2.

The fluid resistor substrate 120 has a fluid resistor layer 120a and a channel layer 120b. The fluid resistor layer 120a has multiple supply fluid resistors 7a as multiple first fluid resistors, and discharge fluid resistors 7b as multiple second fluid resistors. The multiple supply fluid resistors 7a each have a smaller cross-sectional area, which is an opening area parallel to the nozzle face, than the cross-sectional area, which is an opening area parallel to the nozzle face, of the pressure chamber 4.

The supply fluid resistors 7a and the discharge fluid resistors 7b confine crosstalk pressures generated in the respective pressure chambers 4 as much as possible. Thus, the crosstalk pressures that leak from the pressure chambers 4 to the respective supply channel 3a and the respective discharge channel 3b can be reduced.

The channel layer 120b has two supply channels 3a and three discharge channels 3b. The supply channels 3a supply liquid to the respective pressure chambers 4 as first channels. The discharge channels 3b discharge liquid from the respective pressure chambers 4 as second channels. The multiple channel partitions 130a are formed in the channel layer 120b as multiple partitions extending in the X′ direction to cross the respective pressure chambers 4. The channel partitions 130a separate the respective supply channels 3a and the respective discharge channels 3b. As illustrated in FIG. 1, four channel partitions 130a are arranged in the Y′ direction. The common supply channel 31a that communicates with the supply channels 3a is formed on an end of the channel layer 120b in the X direction, i.e., a lower portion in FIG. 2. The common discharge channel 31b that communicates with the discharge channels 3b is formed on the other end of the channel layer 120b, i.e., an upper portion in FIG. 2.

As indicated by arrows R1 in FIG. 2, the liquid that is supplied to the common supply channel 31a flows to the supply channels 3a. Subsequently, the liquid flows along the upper face of the fluid resistor layer 120a in the supply channels 3a. Thus, the liquid is supplied from the supply fluid resistors 7a to the respective pressure chambers 4. The liquid that is not discharged from the nozzles 2 is discharged from the discharge fluid resistors 7b to the respective discharge channels 3b. The liquid that has been discharged to the discharge channels 3b flows along the upper face of the fluid resistor layer 120a in the discharge channels 3b and flows to the common discharge channel 31b, as indicated by arrows R2 in FIG. 2.

The liquid discharge head 1 of the present embodiment can generate a liquid flow to cause the liquid to flow from the supply channels 3a into the pressure chambers 4 and a liquid flow to cause the liquid to flow out to the discharge channels 3b. Accordingly, the liquid in the pressure chambers 4 can be replaced. Accordingly, the liquid in the pressure chambers 4 is actively moved, and air bubbles in the pressure chambers 4 are moved to be easily discharged from the pressure chamber 4. Thus, defective discharge of liquid can be reliably prevented from occurring.

The MEMS process is applied to the silicon substrate to form the supply fluid resistors 7a, the discharge fluid resistors 7b, the supply channels 3a, the discharge channels 3b, the common supply channel 31a, and the common discharge channel 31b on the fluid resistor substrate 120. Specifically, one side of the silicon substrate is dry-etched to form the supply channels 3a, the common supply channel 31a, the discharge channels 3b, and the common discharge channel 31b, and the other side of the silicon substrate is dry-etched to form the supply fluid resistors 7a and the discharge fluid resistors 7b. The silicon substrate may be replaced with an SOI (silicon on insulator) substrate to enhance the dimensional accuracy of the depth of the above-described components when the dry etching is performed. The depths of the fluid resistor portions 7a and 7b are preferably 10 to 1000 μm, and the depths of the supply channels 3a, the discharge channels 3b, the common supply channel 31a, and the common discharge channel 31b are preferably 100 to 1000 μm.

In the above description, an example is described in which the both faces of the silicon substrate were dry-etched to form the supply fluid resistors 7a and the discharge fluid resistors 7b, the supply channels 3a, the discharge channels 3b, the common supply channel 31a, and the common discharge channel 31b. However, the supply fluid resistors 7a and the discharge fluid resistors 7b and the supply channels 3a, the discharge channels 3b, the common supply channel 31a, and the common discharge channel 31b may be separately formed on separate substrates and the separate substrates may be bonded together. For example, the one side, i.e., the fluid resistor layer 120a of the fluid resistor substrate 120 as the silicon substrate is dry-etched to form the supply fluid resistors 7a and the discharge fluid resistors 7b. Next, the other side, i.e., the channel layer 120b of the fluid resistor substrate 120 as the silicon substrate is dry-etched to form the supply channel 3a, the discharge channel 3b, the common supply channel 31a, and the common discharge channel 31b. Subsequently, the fluid resistor layer 120a and the channel layer 120b are bonded together. In the above-described embodiments, an example of using a silicon substrate is described. However, a substrate made of, for example, metal, metal oxide, and resin may be employed.

The sealing substrate 140 is bonded to a side of the fluid resistor substrate 120 opposite the pressure chamber substrate 100. As illustrated in FIGS. 3 and 4, the sealing substrate 140 has a supply communication channel 140a which communicates with the common supply channel 31a, and a discharge communication channel 140b which communicates with the common discharge channel 31b. The sealing substrate 140 is a silicon substrate, and the MEMS process is applied to the sealing substrate 140 to form the supply communication channel 140a and the common discharge channel 31b. Specifically, the silicon substrate is dry-etched to form the supply communication channel 140a and the common discharge channel 31b. A substrate made of, for example, metal, metal oxide, and resin, may be employed instead of the silicon substrate.

The frame 150 is joined to a side of the sealing substrate 140 opposite the fluid resistor substrate 120. The frame 150 has a supply common liquid chamber 6a as a first common liquid chamber and a discharge common liquid chamber 6b as a second common liquid chamber as illustrated in FIGS. 3 and 4. The supply common liquid chamber 6a communicates with the supply communication channel 140a of the sealing substrate 140, and the discharge common liquid chamber 6b communicates with the discharge communication channel 140b of the sealing substrate 140. A liquid inlet 152 is formed in an upper portion of the supply common liquid chamber 6a, and a liquid outlet 151 is formed in an upper portion of the discharge common liquid chamber 6b.

Liquid in an external liquid container is supplied to the common supply channel 31a through the liquid inlet 152, the supply common liquid chamber 6a, and the supply communication channel 140a. Liquid in the common discharge channel 31b passes through the discharge communication channel 140b and the discharge common liquid chamber 6b, and is returned to the external liquid container from the liquid outlet 151 via, for example, an external pump. Accordingly, the liquid in the liquid discharge head 1 is circulated. As a result, it is possible to remove bubbles existing in the liquid discharge head 1 such as in the pressure chamber 4 or in the supply channels 3a and the discharge channels 3b to the outside, and to prevent sedimentation of a component of liquid which is likely to sediment in the supply channels 3a, the discharge channels 3b, the common supply channel 31a, and the common discharge channel 31b of the liquid discharge head 1 when a liquid having a component which is likely to sediment is employed.

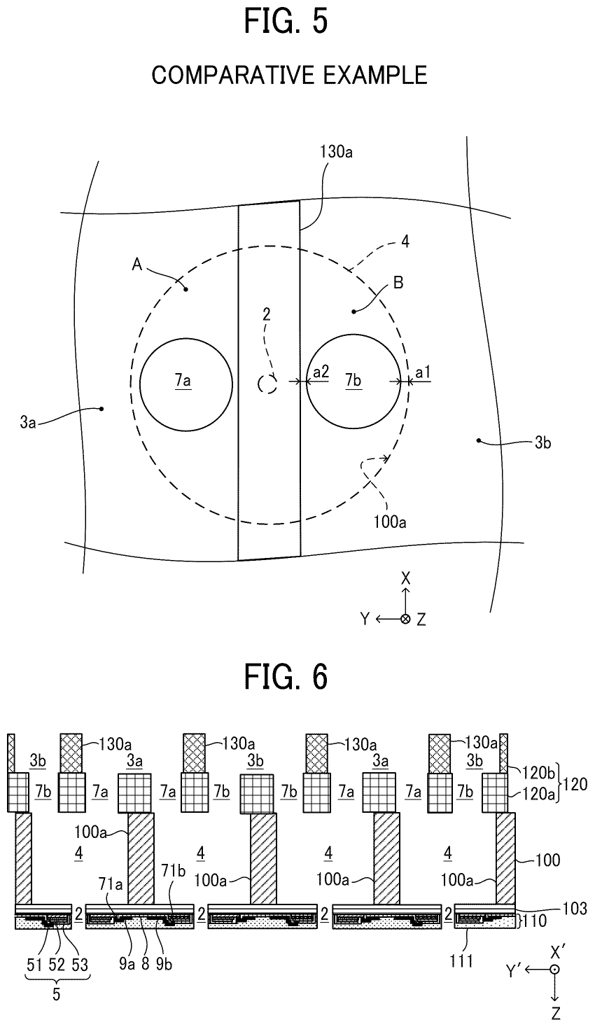

FIG. 5 is a diagram illustrating the supply fluid resistors 7a and the discharge fluid resistors 7b according to a comparative example.

In a liquid discharge head of the nozzle plate vibration method, the nozzle plate of the liquid discharge head vibrates. However, desirably the vibration film 103 displaces almost uniformly on the outline of the circular nozzle 2. This is because if the amount of the displacement of the vibration film 103 varies depending on the position on the outline of the nozzle 2, this may lead to curved discharge of the liquid. For this reason, the pressure chamber 4 is formed in a circular shape or a shape close to a circular shape as illustrated in FIG. 5.

As illustrated in FIG. 5, the channel partition 130a that extends in the X direction is disposed to pass through the center of the circular pressure chambers 4. Accordingly, the channel partition 130a divides each of the pressure chambers 4 into two areas, in other words, a supply channel area A overlapping the supply channel 3a and a discharge channel area B overlapping the discharge channel 3b when viewed from the Z direction. The channel partition 130a is disposed to extend to pass through the center of the circular pressure chamber 4. Thus, the supply channel area A and the discharge channel area B of the pressure chamber 4 has a substantially semicircular shape when viewed from the Z direction.

Accordingly, the maximum length of the supply channel area A and the discharge channel area B of the pressure chamber 4 in the Y direction, i.e., a direction perpendicular to the channel partition 130a, is substantially equal to the radius of the pressure chamber 4. The maximum length of the supply channel area A and the discharge channel area B of the pressure chamber 4 in the X direction, i.e., a direction in which the channel partition 130a extends, is substantially equal to the diameter of the pressure chamber 4. Thus, the X direction is a longitudinal direction of the supply channel area A and the discharge channel area B. The Y direction is a short-side direction of the supply channel area A and the discharge channel area B.

The fluid resistor substrate 120 that has the supply fluid resistors 7a and the discharge fluid resistors 7b is bonded to the pressure chamber substrate 100. However, a positional shift between the fluid resistor substrate 120 and the pressure chamber substrate 100 inevitably occurs when the fluid resistor substrate 120 and the pressure chamber substrate 100 are bonded together. The supply fluid resistors 7a and the discharge fluid resistors 7b of the comparative example each has a circular shape when viewed from the Z direction. When opening areas, i.e., cross-sectional areas of channel, of the supply fluid resistors 7a and the discharge fluid resistors 7b need to be designed to be large, as illustrated in FIG. 5, distances a1 between the partition 100a of the pressure chamber 4 and the supply fluid resistors 7a and the discharge fluid resistors 7b are short in the Y direction. Accordingly, the distances a1 in the Y direction may be smaller than an allowable amount of positional shift when the fluid resistor substrate 120 and the pressure chamber substrate 100 are bonded together.

As illustrated in FIG. 6, when the fluid resistor substrate 120 is bonded to the pressure chamber substrate 100 with the maximum allowable amount of positional shift between the fluid resistor substrate 120 and the pressure chamber substrate 100, a part of one of the supply fluid resistor 7a and the discharge fluid resistor 7b corresponding to corresponding one of the pressure chambers 4 is blocked by the partition 100a of the pressure chamber 4. Accordingly, the fluid resistance of the supply fluid resistor 7a and the discharge fluid resistor 7b deviates from a target value, and the discharge characteristics change compared to a liquid discharge head with a smaller amount of positional shift.

To prevent such a disadvantage, it is possible to increase the size of the pressure chamber 4. However, increasing the size of the pressure chamber 4 may increase the size of the liquid discharge head. In addition, the thickness of the channel partitions 130a is made thinner and the supply fluid resistors 7a and the discharge fluid resistors 7b are shifted closer to corresponding one of the channel partitions 130a. By so doing, the distances a1 between the channel partitions 130a of the pressure chambers 4 and the supply fluid resistors 7a and the discharge fluid resistors 7b may be longer than the allowable amount of positional shift in the Y direction. However, such a configuration causes the shape of the channel partition 130a to be elongated. Accordingly, the rigidity of the channel partition 130a may be reduced.

Further, as illustrated in FIG. 5, when the supply fluid resistors 7a and the discharge fluid resistors 7b are circular when viewed from the Z direction, the distances a2 to the channel partition wall 130 are also short. Accordingly, as described above, in the configuration in which the supply fluid resistors 7a and the discharge fluid resistors 7b are formed on the fluid resistor substrate 120, and the supply channel 3a, the discharge channel 3b, the common supply channel 31a, and the common discharge channel 31b are formed on the pressure chamber substrate 100, and the fluid resistor substrate 120 and the pressure chamber substrate 100 are bonded together, the channel partition 130a may block the supply fluid resistors 7a and the discharge fluid resistors 7b due to the positional shift between the fluid resistor substrate 120 and the pressure chamber substrate 100 in the Y direction. As a result, the fluid resistance of the supply fluid resistors 7a and the discharge fluid resistors 7b deviates from the target value, and the discharge characteristics change. Thus, the desired discharge performance may not be obtained.

For this reason, in the present embodiment, the supply fluid resistors 7a and the discharge fluid resistors 7b are formed such that the supply fluid resistors 7a and the discharge fluid resistors 7b are elongated in the longitudinal direction, i.e., the X direction, of the supply channel area A and the discharge channel area B of the pressure chamber 4, divided by the channel partition 130a when viewed from the Z direction, i.e., the liquid discharge direction.

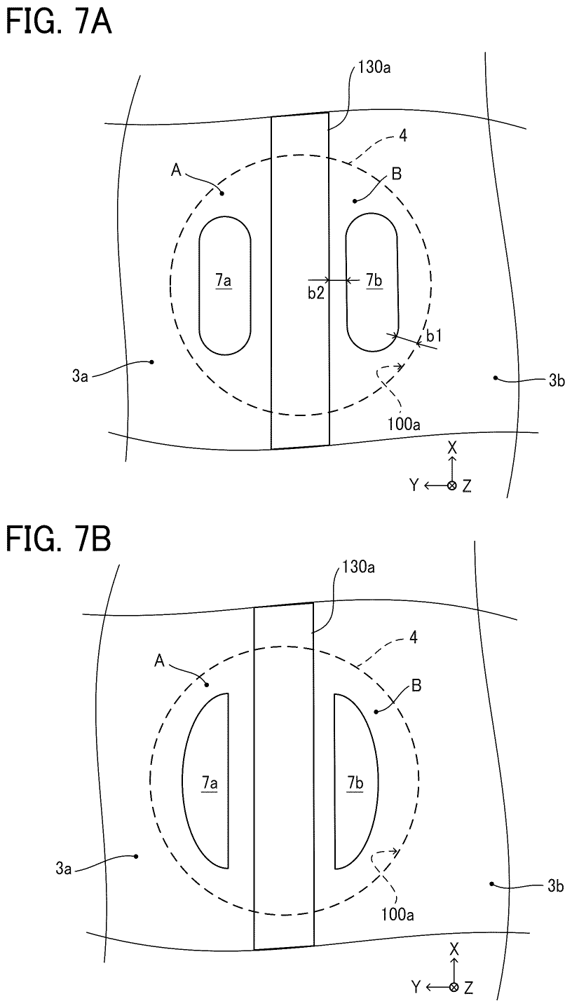

FIGS. 7A and 7B are diagrams each illustrating the supply fluid resistors 7a and the discharge fluid resistors 7b.

The cross-sectional area of the channel of the supply fluid resistors 7a and the discharge fluid resistors 7b illustrated in FIG. 7A has a same size as the cross-sectional area of the channel of the supply fluid resistors 7a and the discharge fluid resistors 7b of the comparative example illustrated in FIG. 5. In the present embodiment, the fluid resistor portions 7a and 7b are formed in a shape elongated in the X direction which is the longitudinal direction of the supply channel area A and the discharge channel area B of the pressure chamber 4. Accordingly, as can be seen from a comparison with FIG. 5, minimum distances b1 between the partition 100a of the pressure chamber 4 and the supply fluid resistor 7a and the discharge fluid resistor 7b can be made longer than the case in which the shape of the cross section of the supply fluid resistor 7a and the discharge fluid resistor 7b is circular. Accordingly, the minimum distances b1 between the partition 100a of the pressure chamber 4 and the supply fluid resistor 7a and the discharge fluid resistor 7b can be made larger than the allowable amount of positional shift when the pressure chamber substrate 100 and the fluid resistor substrate 120 are bonded together without expanding the pressure chamber 4. As a result, it is possible to prevent a part of the supply fluid resistor 7a and the discharge fluid resistor 7b from being blocked by the partition 100a due to the positional shift when the pressure chamber substrate 100 and the fluid resistor substrate 120 are bonded together. Thus, the desired discharge performance can be obtained without increasing the size of the liquid discharge head 1.

In addition, distances b2 between the channel partition 130a and the supply fluid resistors 7a and the discharge fluid resistors 7b can be made longer than the known configuration illustrated in FIG. 5. Accordingly, in the configuration in which the supply fluid resistors 7a and the discharge fluid resistors 7b are formed on the fluid resistor substrate 120, and the supply channel 3a, the discharge channel 3b, the common supply channel 31a, and the common discharge channel 31b are formed on the pressure chamber substrate 100, and the fluid resistor substrate 120 and the pressure chamber substrate 100 are bonded together, it is possible to prevent the channel partition 130a from blocking a part of the supply fluid resistors 7a and the discharge fluid resistors 7b due to the positional shift when the fluid resistor substrate 120 and the pressure chamber substrate 100 are bonded together.

As illustrated in FIG. 7B, the supply fluid resistors 7a and the discharge fluid resistors 7b are formed in a shape similar to the supply channel area A and the discharge channel area B of the pressure chamber 4. By so doing, distances between the supply fluid resistors 7a and the discharge fluid resistors 7b and the partition 100a and the channel partition 130a can be made longer than the allowable amount of positional shift. At the same time, the cross-sectional area of the channel of the supply fluid resistors 7a and the discharge fluid resistors 7b can be increased.

In addition, in the supply fluid resistors 7a and the discharge fluid resistors 7b of the present embodiment, bubble discharge property to discharge bubbles from the pressure chamber 4 is enhanced compared to the supply fluid resistors 7a and the discharge fluid resistors 7b of the comparative example illustrated in FIG. 5. In the configuration in which the supply fluid resistors 7a and the discharge fluid resistors 7b of the comparative example are disposed as illustrated in FIG. 5, distances between the partition 100a and the supply fluid resistor 7a and the discharge fluid resistor 7b are long in the X direction. Accordingly, the flow of the liquid is limited in ends of the pressure chamber 4 in the X direction, and the air bubbles are not easily discharged. By contrast, in the present embodiment, the supply fluid resistor 7a and the discharge fluid resistor 7b are formed in the shape elongated in the X direction, i.e., the longitudinal direction of the supply channel area A and the discharge channel area B. Accordingly, the distances between the partition 100a and the supply fluid resistor 7a and the discharge fluid resistor 7b are shorter in the X direction than in the configuration of the comparative example illustrated in FIG. 5. For this reason, the liquid flows reliably in the ends of the pressure chamber 4 in the X direction, and the air bubbles in the ends of the pressure chamber 4 in the X direction can be reliably discharged.

The shapes of the supply fluid resistors 7a and the discharge fluid resistors 7b illustrated in FIGS. 7A and 7B are examples. The fluid resistance of the supply fluid resistors 7a and the discharge fluid resistors 7b is typically fluid resistance due to liquid inertia and fluid resistance due to liquid viscosity. The fluid resistance due to liquid inertia is determined by the cross-sectional area of the channel and the length in the Z direction of the supply fluid resistors 7a and the discharge fluid resistors 7b. However, the fluid resistance due to liquid viscosity is also affected by the shape of the supply fluid resistors 7a and the discharge fluid resistors 7b. For this reason, the cross-sectional area and shape of the supply fluid resistors 7a and the discharge fluid resistors 7b may be appropriately set according to the target fluid resistance due to liquid inertia and fluid resistance due to liquid viscosity.

Next, a description is given of a modification of the above embodiments of the present disclosure.

### First Modification

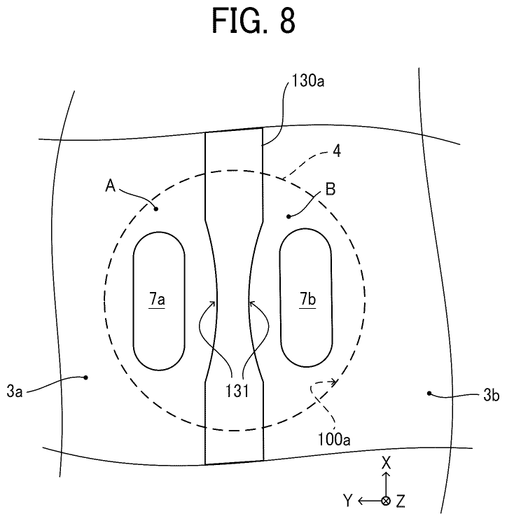

FIG. 8 is a diagram illustrating the supply fluid resistors 7a and the discharge fluid resistors 7b and the surroundings thereof, according to a first modification.

As illustrated in FIG. 8, in the first modification, the channel partition 130a has a recesses 131 in which a portion of the channel partition 130a facing the supply fluid resistors 7a and the discharge fluid resistors 7b is recessed when viewed from the Z direction. Accordingly, the supply fluid resistors 7a and the discharge fluid resistors 7b can be disposed closer to an inner portion of the pressure chamber 4. Thus, the distances between the supply fluid resistors 7a and the discharge fluid resistors 7b and the partition 100a can be made larger, compared to the above embodiments. As a result, it is possible to further prevent a part of the supply fluid resistors 7a and the discharge fluid resistors 7b from being blocked by the partition 100a due to the positional shift when the pressure chamber substrate 100 and the fluid resistor substrate 120 are bonded together.

In addition, in the configuration in which the supply fluid resistors 7a and the discharge fluid resistors 7b are formed on the fluid resistor substrate 120, and the supply channel 3a, the discharge channel 3b, the common supply channel 31a, and the common discharge channel 31b are formed on the pressure chamber substrate 100, it is possible to prevent the channel partition 130a from blocking a part of the supply fluid resistors 7a and the discharge fluid resistors 7b due to the positional shift when the fluid resistor substrate 120 and the pressure chamber substrate 100 are bonded together.

The shape of the recesses 131 on the channel partition 130a needs to be designed in consideration of the mechanical strength of the channel partition 130a. This is because the larger the recesses 131, the thinner the channel partition 130a at a portion at which recesses 131 are formed, and the lower the mechanical strength of the channel partition 130a. Accordingly, for example, when force is applied at a time at which the channel partition 130a is bonded with the sealing substrate 140, the channel partition 130a may be broken.

### Second Modification

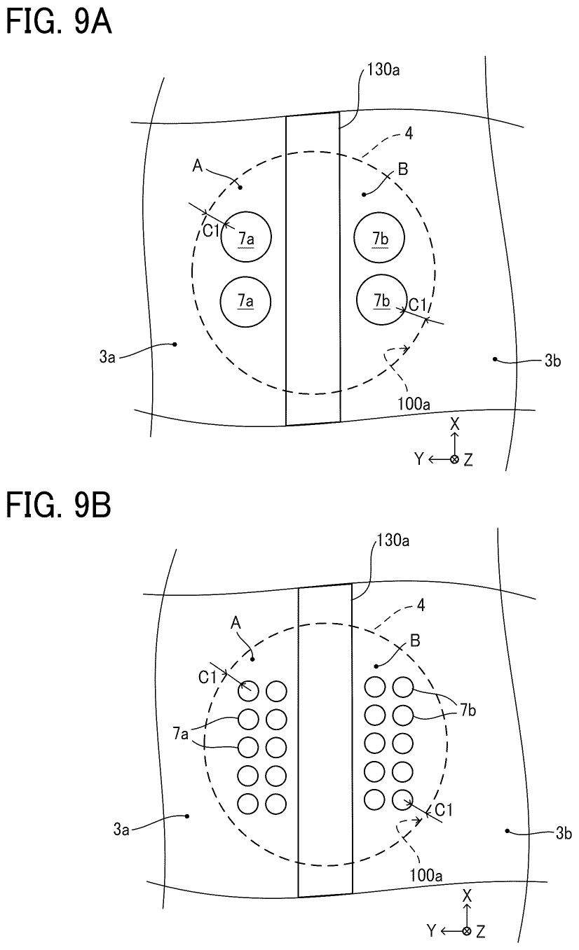

FIGS. 9A and 9B are diagrams each illustrating the supply fluid resistors 7a and the discharge fluid resistors 7b according to a second modification and the surroundings thereof.

In the second modification, as illustrated in FIGS. 9A and 9B, the multiple supply fluid resistors 7a and the multiple discharge fluid resistors 7b are disposed. FIG. 9A is a diagram illustrating a configuration in which the two supply fluid resistors 7a and the two discharge fluid resistors 7b are disposed in the supply channel area A and the discharge channel area B, respectively, in the longitudinal direction, i.e., the X direction. FIG. 9B is a diagram illustrating a configuration in which two rows of the supply fluid resistors 7a and the discharge fluid resistors 7b are arranged in the supply channel area A and the discharge channel area B, respectively, in the longitudinal direction, i.e., the X direction. In both FIG. 9A and FIG. 9B, areas in which the multiple supply fluid resistors 7a and the multiple discharge fluid resistors 7b are disposed are elongated in the longitudinal direction, i.e., the X direction of the supply channel area A and the discharge channel area B of the pressure chamber 4.

Also in the second modification, the multiple supply fluid resistors 7a and the multiple discharge fluid resistors 7b are disposed in the longitudinal direction, i.e., the X direction of at least the supply channel area A and the discharge channel area B, and the areas in which the multiple the supply fluid resistors 7a and the discharge fluid resistors 7b are disposed are elongated in the longitudinal direction, i.e., the X direction of the supply channel area A and the discharge channel area B of the pressure chamber 4. Thus, the total cross-sectional area of channel of the supply fluid resistors 7a and the total cross-sectional area of channel of the discharge fluid resistors 7b is set as a target value of the cross-sectional area of channel. By so doing, minimum distances C1 between the supply fluid resistors 7a and the discharge fluid resistors 7b and the partition 100a of the pressure chamber 4 can be made larger than the allowable amount of positional shift. Accordingly, also in the second modification, it is possible to prevent a part of the supply fluid resistor 7a and the discharge fluid resistor 7b from being blocked by the partition 100a due to the positional shift when the pressure chamber substrate 100 and the fluid resistor substrate 120 are bonded together.

The second modification is suitable for a case in which the fluid resistance due to liquid viscosity is increased as compared with the fluid resistance due to liquid inertia.

### Third Modification

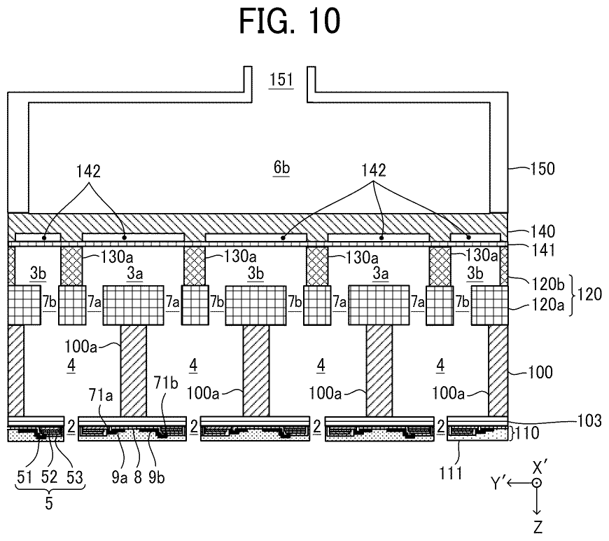

FIG. 10 is a schematic cross-sectional view of a liquid discharge head according to a third modification.

As illustrated in FIG. 10, the liquid discharge head of the third modification includes a damper 141 on a lower face of the sealing substrate 140, facing the fluid resistor substrate 120.

Portions of the sealing substrate 140 facing the channels 3a and 3b of the fluid resistor substrate 120 is removed by dry etching to form air layers 142. Subsequently, the damper 141 is attached to the face of the sealing substrate 140 facing the fluid resistor substrate 120. The damper 141 is a film (damper film) made of metal or resin material, and the damper 141 defines walls, i.e., upper walls of the channels 3a and 3b. The damper 141 is preferably made of metal or resin.

Such a configuration as described above allows the damper 141 to be deformed in accordance with pressure wave and inertial flow of the crosstalk which transmits to the liquid in the channels 3a and 3b, and can reduce the pressure wave and the inertial flow of the crosstalk generated in the channels 3a and 3b. Thus, the crosstalk can be reduced.

### Fourth Modification

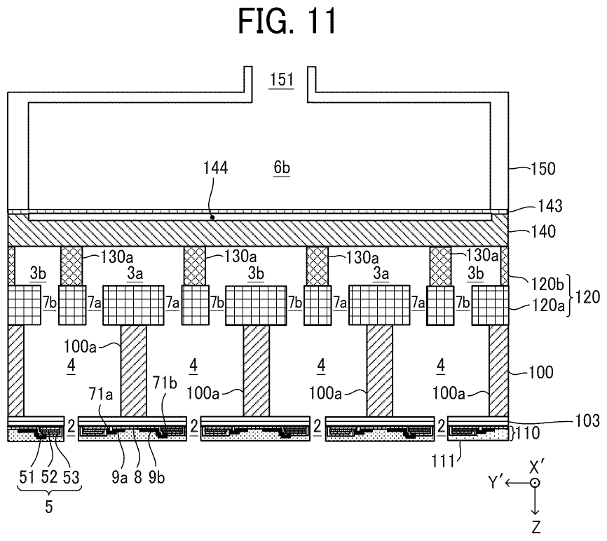

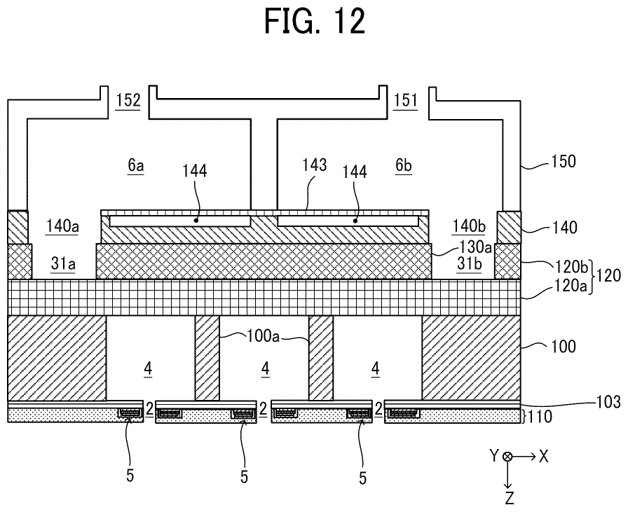

FIG. 11 is a schematic cross-sectional view of a liquid discharge head according to a fourth modification. FIG. 12 is a schematic cross-sectional view of the liquid discharge head of the fourth modification, taken along a line D-D′ in FIG. 2.

The liquid discharge head of the fourth modification includes a damper 143 on an upper face of the sealing substrate 140, opposite the fluid resistor substrate 120. The damper 143 defines a bottom of the supply common liquid chamber 6a and a bottom of the discharge common liquid chamber 6b.

Portions of the sealing substrate 140 that face the common liquid chambers 6a and 6b via the damper 143 and closer to the frame 150 are removed by dry etching to form air layers 144. By so doing, the portions of the damper 143, which defines the bottom of the supply common liquid chamber 6a and the bottom of the discharge common liquid chamber 6b, are deformable. The damper 143 is a film (damper film) made of metal or resin material, similar to the third modification.

Such a configuration as described above allows the damper 143 to be deformed in accordance with pressure waves or inertial flows transmitted from the liquid inlet 152 and the liquid outlet 151. Accordingly, pressure fluctuation in the supply common liquid chamber 6a the discharge common liquid chamber 6b can be reduced.

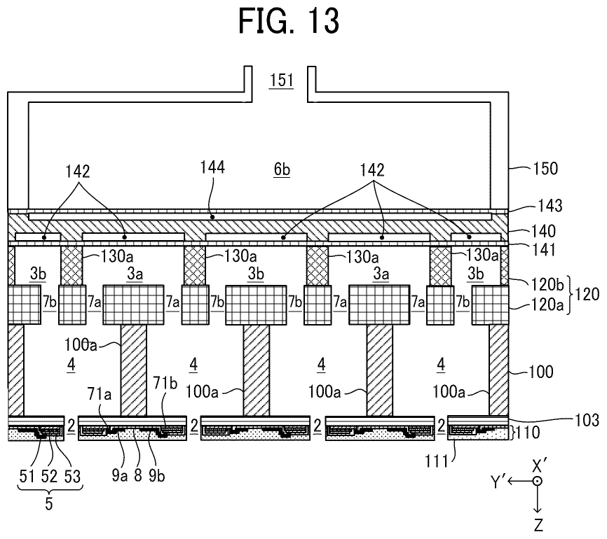

Further, as illustrated in FIG. 13, the liquid discharge head of the fourth modification may include dampers 141 and 143 on both faces of the sealing substrate 140 to prevent the pressure fluctuation in the supply channel 3a, the discharge channel 3b, the supply common liquid chamber 6a, and the discharge common liquid chamber 6b.

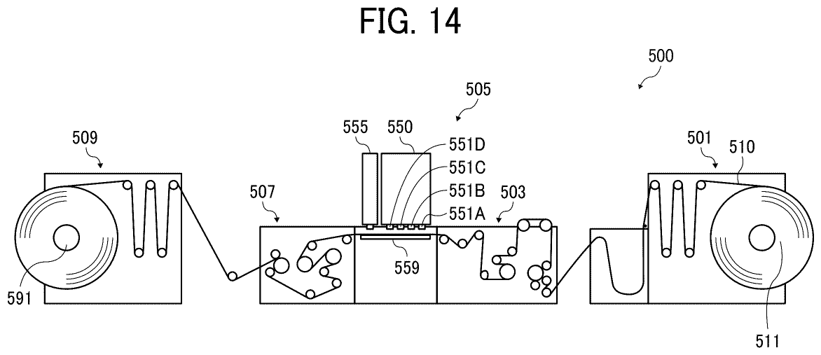

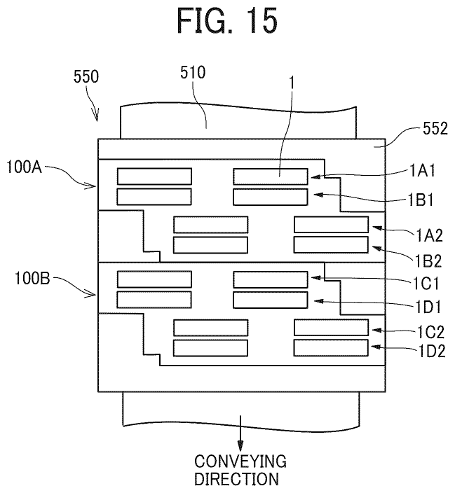

Next, a description is given below of an example of the liquid discharge apparatus according to embodiments of the present disclosure with reference to FIGS. 14 and 15.

FIG. 14 is a schematic diagram illustrating a printer 500 which is an inkjet recording apparatus as a liquid discharge apparatus which discharges liquid, according to embodiments of the present disclosure.

FIG. 15 is a plan view of a head unit of the printer 500.

The printer 500, which is an apparatus for discharging liquid, includes a feeder 501 and a guide conveyor 503. The feeder 501 feeds a continuous medium 510. The guide conveyor 503 guides and conveys the continuous medium 510 conveyed from the feeder 501 to a printing device 505. The printer 500 also includes the printing device 505, a drier 507, and an ejector 509. The printing device 505 discharges liquid onto the continuous medium 510 to form an image. The drier 507 dries the continuous medium 510. The ejector 509 ejects the continuous medium 510.

The continuous medium 510 (i.e., a medium) is fed from a winding roller 511 of the feeder 501, guided and conveyed with rollers of the feeder 501, the guide conveyor 503, the drier 507, and the ejector 509, and wound around a take-up roller 591 of the ejector 509. In the printing device 505, the continuous medium 510 is conveyed on a conveyance guide 559 so as to face a head unit 550. The head unit 550 discharges liquid onto the continuous medium 510 to form an image.

In the printer 500 according to the present embodiment, the head unit 550 includes the two head modules 100A and 100B according to the present embodiment on a common base 552.

As illustrated in FIG. 15, the head module 100A includes head arrays 1A1, 1B1, 1A2, and 1B2. Each of the head arrays 1A1, 1B1, 1A2, and 1B2 includes multiple heads 1 arranged in a head array direction perpendicular to a conveyance direction of the sheet P as indicated by arrow in FIG. 15. The head module 100B includes head arrays 1C1, 1D1, 1C2, and 1D2. Each of the head arrays 1C1, 1D1, 1C2, and 1D2 includes multiple heads 1 arranged in the head array direction perpendicular to the conveyance direction of the sheet P. The multiple heads 1 in each of the head arrays 1A1 and 1A2 of the head module 100A discharge liquid of the same desired color. Similarly, the head arrays 1B1 and 1B2 of the head module 100A are grouped as one set and discharge a liquid of the same desired color. The head arrays 1C1 and 1C2 of the head module 100B are grouped as one set and discharge a liquid of the same desired color. The head arrays 1D1 and 1D2 of the head module 100B are grouped as one set and discharge a liquid of the same desired color.

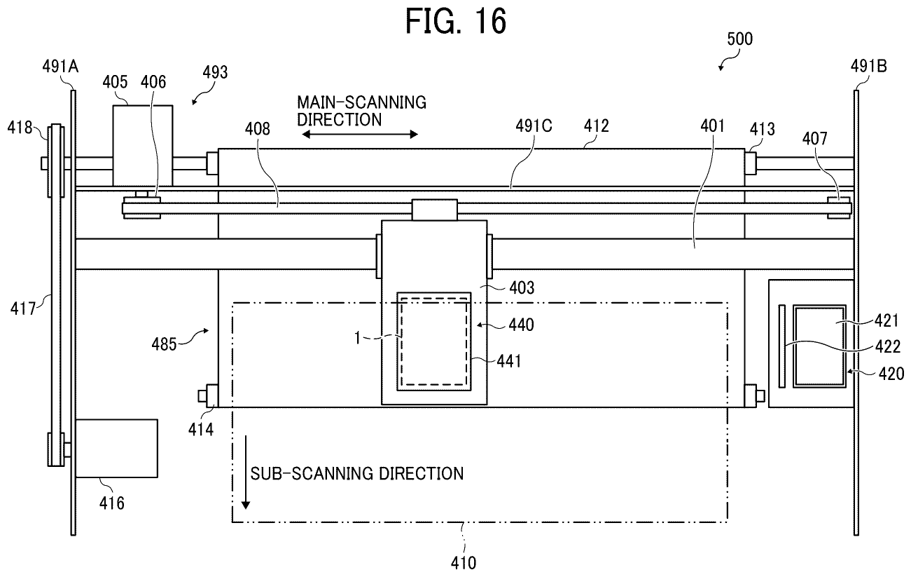

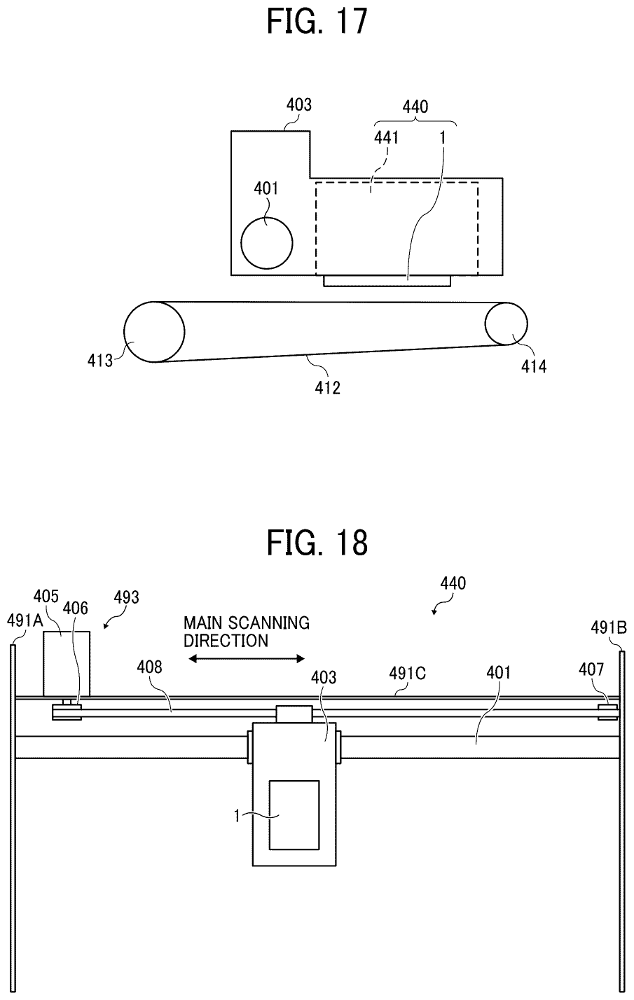

Another printer 500 as a liquid discharge apparatus is described below with reference to FIGS. 16 and 17.

FIG. 16 is a plan view of a part of the printer 500.

FIG. 17 is a side view of the part of the printer 500.

The printer 500 is a serial-type inkjet recording apparatus, and a carriage 403 is reciprocally moved in a main-scanning direction indicated by arrow “Main-Scanning Direction” in FIG. 16 by a main-scanning moving mechanism 493. The main-scanning moving mechanism 493 includes, for example, a guide 401, a main-scanning motor 405, and a timing belt 408. The guide 401 is bridged between a left-side plate 491A and a right-side plate 491B to movably hold the carriage 403.

The main-scanning motor 405 reciprocates the carriage 403 in the main scanning direction via the timing belt 408 looped around a drive pulley 406 and a driven pulley 407.

The carriage 403 includes a liquid discharge unit 440 in which the liquid discharge head 1 and a head tank 441 are integrated into a single unit. The liquid discharge head 1 discharges color liquids of, for example, yellow (Y), cyan (C), magenta (M), and black (K).

The liquid discharge head 1 includes a nozzle array including multiple nozzles 11 arrayed in a sub-scanning direction as indicated by arrow “sub-scanning direction”. The sub-scanning direction is orthogonal to the main scanning direction. The liquid discharge head 1 is mounted to the carriage 403 so that ink droplets are discharged downward. The liquid discharge head 1 is connected to a liquid circulation device, and a liquid of a required color is circulated and supplied.

The printer 500 includes a conveyor 495 to convey a sheet 410. The conveyor 495 includes a conveyance belt 412 as a conveyor and a sub-scanning motor 416 to drive the conveyance belt 412. The conveyance belt 412 attracts the sheet 410 and conveys the sheet 410 to a position facing the head 1. The conveyance belt 412 is an endless belt stretched between a conveyance roller 413 and a tension roller 414. Attraction of the sheet 410 to the conveyance belt 412 may be applied by, for example, electrostatic adsorption, air suction. The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head 1 is disposed lateral to the conveyance belt 412. The maintenance mechanism 420 includes, for example, a cap 421 to cap the nozzle face of the liquid discharge head 1 and a wiper 422 to wipe the nozzle face. The main-scanning moving mechanism 493, the maintenance mechanism 420, and the conveyor 495 are mounted onto a housing including the left-side plates 491A, the right-side plate 491B, and a back plate 491C.

In the printer 500 having the above-described configuration, the sheet 410 is fed and attracted onto the conveyance belt 412 and conveyed in the sub-scanning direction by the circumferential movement of the conveyance belt 412. The liquid discharge head 1 is driven in response to an image signal while the carriage 403 is moved in the main-scanning direction to discharge liquid onto the sheet 410 not in motion to form an image.

Another liquid discharge unit 440 is described below with reference to FIG. 18.

FIG. 18 is a plan view of a part of the liquid discharge unit 440.

The liquid discharge unit 440 includes the housing, the main-scanning moving mechanism 493, the carriage 403, and the liquid discharge head 1 among components of the printer 500 as the liquid discharge apparatus illustrated in FIG. 17. The left-side plates 491A. the right-side plate 491B, and the back plate 491C construct the housing.

In the liquid discharge unit 440, the maintenance mechanism 420 described above may be mounted on, for example, the right-side plate 491B.

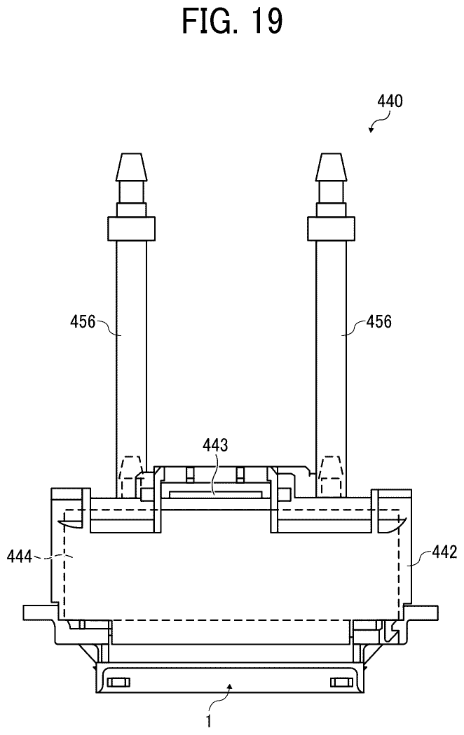

Still another liquid discharge unit 440 is described below with reference to FIG. 19.

FIG. 19 is a front view of the liquid discharge unit 440.

The liquid discharge unit 440 includes the liquid discharge head 1 to which a channel component 444 is attached, and a tube 456 connected to the channel component 444.

The channel component 444 is disposed inside a cover 442. Alternatively, the liquid discharge unit 440 may include the head tank 441 instead of the channel component 444. A connector 443 that is electrically connected to the liquid discharge head 1 is disposed on an upper portion of the channel component 444.

In embodiments of the present disclosure, the liquid to be discharged is not limited to a particular liquid as long as the liquid has a viscosity or surface tension to be discharged from a head (liquid discharge head). However, preferably, the viscosity of the liquid is not greater than 30 millipascal-second (mPa s) by heating. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; or an edible material, such as a natural colorant, or molten metal, such as solder. Such a solution, a suspension, an emulsion, or molten metal can be used for, e.g., inkjet ink, surface treatment solution, a liquid for forming components of electronic element or light-emitting element or a resist pattern of electronic circuit, a liquid for forming a solder bump, or a material solution for three-dimensional fabrication.

The “liquid discharge unit” is an assembly of parts relating to liquid discharge. The term “liquid discharge unit” represents a structure including the liquid discharge head and a functional part(s) or unit(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

Examples of the “single unit” include a combination in which the head and one or more functional parts and units are secured to each other through, e.g., fastening, bonding, or engaging, and a combination in which one of the head and the functional parts and units is movably held by another. The liquid discharge head may be detachably attached to the functional part(s) or unit(s) each other.

For example, the liquid discharge head and the head tank are integrated to form the liquid discharge unit as a single unit. Alternatively, the liquid discharge head and the head tank coupled (connected) to each other via, for example, a tube may form the liquid discharge unit as a single unit. A unit including a filter may also be added to a portion between the head tank and the liquid discharge head of the liquid discharge unit.

In another example, the head and the carriage may form the liquid discharge device as a single unit.

In still another example, the liquid discharge device may include the liquid discharge head movably held by a guide that forms a part of a main-scanning movement device, such that the liquid discharge head and the main-scanning movement device are integrated as a single unit. In still another example, the liquid discharge unit may include the liquid discharge head, the carriage, and the main-scanning moving mechanism that are integrated as a single unit.

In still another example, a cap that forms a part of the maintenance unit may be secured to the carriage mounting the head so that the head, the carriage, and the maintenance unit form a single unit to form the liquid discharge device.

Further, in still another example, the liquid discharge unit includes tubes connected to the liquid discharge head mounting the head tank or the channel component so that the liquid discharge head and the supply mechanism are integrated as a single unit. Through the tubes, the liquid in a liquid storage source is supplied to the liquid discharge head.

The main-scanning movement mechanism also includes a single piece of guide member. The supply mechanism may be a tube(s) only or a loading device only.

The “liquid discharge unit” includes a head module including the above-described liquid discharge head, and a head unit with which the above-described functional components or mechanisms are combined to form a single unit.

The “liquid discharge apparatus” used herein also represents an apparatus including the head, the liquid discharge unit, the head module, or the head unit to drive the liquid discharge head to discharge liquid. The liquid discharge apparatus may be, for example, any apparatus that can discharge liquid to a medium onto which liquid can adhere or any apparatus to discharge liquid toward gas or into a different liquid.

The liquid discharge apparatus may include devices to feed, convey, and eject the material on which liquid can adhere. The liquid discharge apparatus may further include a pretreatment apparatus to coat a treatment liquid onto the material, and a post-treatment apparatus to coat a treatment liquid onto the material, onto which the liquid has been discharged.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The liquid discharge apparatus is not limited to an apparatus to discharge liquid to visualize meaningful images, such as letters or figures. For example, the liquid discharge apparatus may be an apparatus to form meaningless images, such as meaningless patterns, or fabricate three-dimensional images.

The above-described term “material onto which liquid can adhere” represents a material on which liquid is at least temporarily adhered, a material on which liquid is adhered and fixed, or a material into which liquid is adhered to permeate. Examples of the “material on which liquid can adhere” include recording media, such as paper sheet, recording paper, recording sheet of paper, film, and cloth, electronic component, such as electronic substrate and piezoelectric element, and media, such as powder layer, organ model, and testing cell. The “material on which liquid can adhere” includes any material on which liquid can adhere, unless particularly limited.

Examples of the “material onto which liquid can adhere” include any materials on which liquid can adhere even temporarily, such as paper, thread, fiber, fabric, leather, metal, plastic, glass, wood, and ceramic.

The “liquid discharge apparatus” may be an apparatus to relatively move the head and a material on which liquid can adhere. However, the liquid discharge apparatus is not limited to such an apparatus. For example, the liquid discharge apparatus may be a serial head apparatus that moves the head or a line head apparatus that does not move the head.

Examples of the “liquid discharge apparatus” further include a treatment liquid coating apparatus to discharge the liquid to a sheet to coat the treatment liquid on a sheet surface to reform the sheet surface and an injection granulation apparatus in which a composition liquid including raw materials dispersed in a solution is discharged through nozzles to granulate fine particles of the raw materials. Further, there is an injection granulation apparatus for spraying a composition liquid in which raw materials are dispersed in a solution through a nozzle to granulate fine particles of the raw material.

The terms “image formation”, “recording”, “printing”, “image printing”, and “fabricating” used herein may be used synonymously with each other.

The embodiments described above are examples, and the following aspects of the present disclosure can attain, for example, the following effects.

### First Aspect

A liquid discharge head such as the liquid discharge head 1 includes a nozzle layer, such as a nozzle plate 110 having nozzles 2, a pressure chamber layer such as the pressure chamber substrate 100 having the pressure chamber 4 communicating with the nozzle 2, a first fluid resistor such as the supply fluid resistor 7a communicating with the chamber 4, a fluid resistor layer such as the fluid resistor layer 120a having a second fluid resistor such as the discharge fluid resistor 7b communicating with the pressure chamber 4, a first channel such as the supply channel 3a communicating with the first fluid resistor, a second channel such as the discharge channel 3b communicating with the second fluid resistor, and a channel layer such as the channel layer 120b having a channel partition such as the channel partition 130a to partition the first channel and the second channel. The first fluid resistor has a shape elongated in the longitudinal direction of an area such as the supply channel area A, overlapping the first channel of the pressure chamber 4, when viewed from the liquid discharge direction, i.e., the Z direction. The second fluid resistor has a shape elongated in the longitudinal direction of an area such as the discharge channel area B, overlapping the second channel of the pressure chamber.

In a known liquid discharge head, the pressure chamber has a circular shape when viewed from the liquid discharge direction, and the partition wall extends to pass through the center of the circular pressure chamber. For this reason, the shape of the area of the pressure chamber overlapping the first channel and the shape of the area of the pressure chamber overlapping the second channel are both semicircular when viewed from the liquid discharge direction. Accordingly, the longitudinal direction of the area of the pressure chamber overlapping the first channel and the area of the pressure chamber overlapping the second channel is the direction in which the partition wall extends to pass through the center of the circular pressure chamber. A short-side direction of the area of the pressure chamber overlapping the first channel and the area of the pressure chamber overlapping the second channel is an orthogonal direction orthogonal to the direction in which the partition wall extends to pass through the center of the circular pressure chamber.

The first fluid resistor and the second fluid resistor included in the above-described known liquid discharge head have a round hole shape. Accordingly, in the orthogonal direction which is the short-side direction of the area of the pressure chamber overlapping the first channel and the area of the pressure chamber overlapping the second channel, the distance from the first fluid resistor and the second fluid resistor to the side wall of the pressure chamber may be shorter than the allowable amount of positional shift (attachment error) when the fluid resistor layer and the pressure chamber layer are bonded together. Accordingly, depending on the amount of the attachment error, a part of the first fluid resistor or the second fluid resistor may not face the pressure chamber, and a part of the first fluid resistor or the second fluid resistor may be blocked by the pressure chamber layer. Accordingly, a desired fluid resistance cannot be obtained, and a desired discharge characteristics may not be obtained. In the orthogonal direction, the distance from the first fluid resistor and the second fluid resistor to the partition wall may be shorter than the amount of attachment error of the fluid resistor layer with respect to the channel layer, and a part of the first fluid resistor and the second fluid resistor may be blocked by the partition wall. As a result, a desired fluid resistance may not be obtained, and a desired discharge characteristics may not be obtained.

By contrast, in the liquid discharge head of the first aspect, when viewed from the liquid discharge direction, the first fluid resistor and the second fluid resistor has a shape elongated in the longitudinal direction of the area overlapping the respective channels of the pressure chamber. Such a configuration as described above allows the minimum distance from the first fluid resistor and the second fluid resistor to the side wall of the pressure chamber to be larger than the amount of the attachment error of the fluid resistor layer with respect to the pressure chamber layer, compared to the case in which the first fluid resistor and the second fluid resistor each has a round hole, when the cross-sectional area of the channel of the first fluid resistor and the second fluid resistor is the same as the cross-sectional area of the channel of the first fluid resistor and the second fluid resistor each has a circular shape. Accordingly, it is possible to prevent a part of the first fluid resistor or the second fluid resistor from not facing the pressure chamber.

In addition, the minimum distance from the first fluid resistor and the second fluid resistor to the partition wall can be made larger than the amount of the attachment error of the fluid resistor layer with respect to the channel layer. Accordingly, it is possible to prevent a part of the first fluid resistor or the second fluid resistor from being blocked by the partition wall. As described above, it is possible to prevent a part of the first fluid resistor and the second fluid resistor from being blocked by the partition wall or the channel partition wall of the pressure chamber. Thus, desired discharge characteristics can be obtained.

### Second Aspect

In the liquid discharge head according to the first aspect, the pressure chamber has a circular shape concentric with the nozzle as a round hole when viewed from the liquid discharge direction, i.e., the Z direction. The first fluid resistor such as the supply fluid resistor 7a and the second fluid resistor such as the discharge fluid resistor 7b are formed in a shape elongated in the direction, i.e., the X direction, in which the partition such as the channel partition 130a extends. According to this configuration, as described in the above embodiments, the minimum distances from the first fluid resistor such as the supply fluid resistor 7a and the second fluid resistor such as the discharge fluid resistor 7b to the partition such as the partition 100a of the pressure chamber 4 can be made larger than the amount of the attachment error between the fluid resistor layer such as fluid resistor layer 120a and the pressure chamber layer such as the pressure chamber substrate 100. In addition, the minimum distances from the first fluid resistor and the second fluid resistor to the partition such as the channel partition 130a are also made larger than the amount of the attachment error between the channel layer and the fluid resistor layer. Accordingly, the cross-sectional area of the channel of the first fluid resistor and the second fluid resistor can be set to desired cross-sectional area.

### Third Aspect

In the liquid discharge head according to the first or second aspect, the first fluid resistor such as the supply fluid resistor 7a and the second fluid resistor such as the discharge fluid resistor 7b are each disposed for each of the pressure chambers 4. Such a configuration as described above allows the crosstalk pressures generated in the pressure chambers 4 to be confined in a satisfactory manner, and to reduce the crosstalk pressures leaking from the respective pressure chambers 4 to the supply channel 3a and the discharge channel 3b.

### Fourth Aspect

A liquid discharge head such as the liquid discharge head 1 includes a nozzle layer, such as a nozzle plate 110 having nozzles 2, a pressure chamber layer such as the pressure chamber substrate 100 having the pressure chamber 4 communicating with the nozzle 2, a first fluid resistor such as the supply fluid resistor 7a communicating with the chamber 4, a fluid resistor layer such as the fluid resistor layer 120a having a second fluid resistor such as the discharge fluid resistor 7b communicating with the pressure chamber 4, a first channel such as the supply channel 3a communicating with the first fluid resistor, a second channel such as the discharge channel 3b communicating with the second fluid resistor, and a channel layer such as the channel layer 120b having a channel partition such as the channel partition 130a to partition the first channel and the second channel. When viewed from the liquid discharge direction (Z direction), multiple first fluid resistor parts are disposed in the longitudinal direction of an area (supply channel area A) overlapping with the first channel of the pressure chamber 4, and multiple second fluid resistor parts are disposed in the longitudinal direction of an area (discharge channel area B) overlapping with the second channel of the pressure chamber 4. According to this, as described in the second modification, the total flow passage cross-sectional area can be set to a desired flow passage cross-sectional area, and the minimum distances of the respective fluid resistor portions to the partition 100a of the pressure chamber 4 can be made longer than the mounting errors between the fluid resistor layer 120a and the pressure chamber layer. Further, the total flow passage cross-sectional area can be set to a desired flow passage cross-sectional area, and the minimum distances of the respective fluid resistor portions to the partitions such as the channel partitions 130a can be made longer than the mounting errors between the fluid resistor layer 120a and the flow passage layer.

### Fifth Aspect

In the liquid discharge head according to the fourth aspect, the pressure chamber has a circular shape concentric with the nozzle as a round hole when viewed from a direction in which liquid is discharged. The liquid discharge head includes multiple first fluid resistors such as the supply fluid resistors 7a and multiple second fluid resistor such as the discharge fluid resistors 7b. The first fluid resistors and the second fluid resistors are formed in a direction, i.e., the X direction, in which the partition such as the channel partition 130a extends, when viewed from a direction in which liquid is discharged. According to this, as described in the third modification, the total cross-sectional area of channel can be set to a desired cross-sectional area of channel, and minimum distances between the first fluid resistor and the second fluid resistor and the partition 100a of the pressure chamber 4 can be made larger than the amount of the attachment error between the fluid resistor layer 120a and the pressure chamber layer. Further, the total cross-sectional area of channel can be set to a desired cross-sectional area of channel, and the minimum distances between the first fluid resistor and the second fluid resistor and the partitions such as the channel partition 130a can be made larger than the amount of the attachment error between the fluid resistor layer 120a and the channel layer.

### Sixth Aspect

In the liquid discharge head according to the fourth or fifth aspect, an area in which the first fluid resistor such as the multiple the supply fluid resistors 7a and the second fluid resistor such as the discharge fluid resistors 7b are disposed are elongated in the longitudinal direction of an area overlapping the first channel such as the supply channel 3a of the pressure chamber 4 and an area in which the second fluid resistor such as the multiple discharge fluid resistors are disposed is elongated in the longitudinal direction of an area overlapping the supply channel such as the discharge channel 3b of the pressure chamber 4. According to this, as described in the first modification, the total cross-sectional area of channel can be set to a desired cross-sectional area of channel, and the minimum distances between the first fluid resistor and the second fluid resistor and the partition 100a can be made larger than the amount of the attachment error between fluid resistor layer 120a and the pressure chamber layer.

### Seventh Aspect

In the liquid discharge head according to any one of the first or sixth aspect, a damper 141 is disposed on a lower face of the sealing substrate 140 opposite the fluid resistor layer such as the first channel and the second channel. According to this, as described in the third modification, the damper 141 is deformed in accordance with pressure wave and inertial flow of the crosstalk which transmits to the liquid in the channels 3a and 3b, and can reduce the pressure wave and the inertial flow of the crosstalk generated in the channels 3a and 3b. Thus, the crosstalk can be reduced.

### Eighth Aspect

The liquid discharge head according to any one of the first or seventh aspect further includes a first common liquid chamber such as the supply common liquid chamber 6a communicating with the first channel such as the supply channel 3a, and a second common liquid chamber such as the discharge common liquid chamber 6b communicating with a second channel such as the discharge channel 3b. The damper 143 defines a part of a wall of the first common liquid chamber and the second common liquid chamber. According to this configuration, as described in the fourth modification, the damper 143 is deformed in accordance with pressure waves or inertial flows transmitted from the outside to the first common liquid chamber and the second common liquid chamber. Accordingly, pressure fluctuation in the first common liquid chamber and the second common liquid chamber can be reduced.

### Ninth Aspect

In the liquid discharge head according to any one of the first or eighth aspect, a partition such as the channel partition 130a has recesses in which a portion of the partition facing the first fluid resistor such as the supply fluid resistors 7a and the second fluid resistor such as the discharge fluid resistors 7b, when viewed from the direction, i.e., the Z direction, in which liquid is discharged. According to this, as described in the first modification, the first fluid resistor such as the supply fluid resistors 7a and the second fluid resistor such as the discharge fluid resistors 7b can be disposed closer to the inner side of the pressure chamber 4. Thus, the distances between the first fluid resistor and the second fluid resistor and the partition such as the partition 100a of the pressure chamber can be made larger, compared to the above embodiments in which the partition do not have recesses.

### Tenth Aspect

In the liquid discharge head according to any one of the first or ninth aspect, the nozzle layer such as the nozzle plate 110 includes a piezoelectric body such as the piezoelectric body 5. According to this, as described in the above embodiments, the liquid discharge head can discharge droplets with a smaller power than a liquid discharge head which vibrates a face of a pressure chamber opposed to a wall (nozzle communication wall) having a communication opening communicating with the nozzle to discharge liquid. Thus, it is possible to achieve power saving of an actuator.

### Eleventh Aspect

A liquid discharge apparatus includes a liquid discharge head such as the liquid discharge head 1 according to any one of the first to tenth aspect. According to this, desired discharge performance can be obtained.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle layer having multiple nozzles arrayed in a first direction, the multiple nozzles to discharge a liquid in a discharge direction orthogonal to the first direction;
a pressure chamber layer over the nozzle layer in the discharge direction, the pressure chamber layer having a pressure chamber communicating with the multiple nozzles;
a fluid resistor layer over the pressure chamber layer in the discharge direction, the fluid resistor layer having:
a first fluid resistor communicating with the pressure chamber; and
a second fluid resistor communicating with the pressure chamber;
a channel layer over the fluid resistor layer in the discharge direction, the channel layer having:
a first channel communicating with the first fluid resistor;
a second channel communicating with the second fluid resistor; and
a partition partitioning the first channel and the second channel,
wherein the first fluid resistor is elongated in a second direction orthogonal to each of the first direction and the discharge direction in an area overlapping with the first channel of the pressure chamber in a plan of the pressure chamber layer, and
the second fluid resistor is elongated in the second direction in an area overlapping the second channel of the pressure chamber in the plan.

2. The liquid discharge head according to claim 1,
wherein the pressure chamber has a circular shape concentric with the nozzle having a round hole in the plan,
the partition extends in the second direction passing through a center of the pressure chamber in the plan, and
each of the first fluid resistor and the second fluid resistor is elongated in the second direction in the plan.

3. The liquid discharge head according to claim 1,
wherein one first fluid resistor and one second fluid resistor are disposed for one pressure chamber.

4. A liquid discharge head comprising:
a nozzle layer having multiple nozzles arrayed in a first direction, the multiple nozzles to discharge a liquid in a discharge direction orthogonal to the first direction;
a pressure chamber layer over the nozzle layer in the discharge direction, the pressure chamber layer having a pressure chamber communicating with the multiple nozzles;
a fluid resistor layer over the pressure chamber layer in the discharge direction, the fluid resistor layer having:
multiple first fluid resistors communicating with the pressure chamber; and
multiple second fluid resistors communicating with the pressure chamber;
a channel layer over the fluid resistor layer in the discharge direction, the channel layer having:
a first channel communicating with the first fluid resistor;
a second channel communicating with the second fluid resistor; and
a partition partitioning the first channel and the second channel,
wherein the multiple first fluid resistors are arrayed in the second direction in an area overlapping the first channel of the pressure chamber in the plan, and
the multiple second fluid resistors are arrayed in the second direction in an area overlapping the second channel of the pressure chamber in the plan.

5. The liquid discharge head according to claim 4,
wherein the pressure chamber has a circular shape concentric with the nozzle having a round hole in the plan,
the partition extends in the second direction passing through a center of the pressure chamber in the plan, and
the multiple first fluid resistors and the multiple second fluid resistors are arrayed in the second direction.

6. The liquid discharge head according to claim 4,
wherein the multiple first fluid resistors are arrayed in a first region, elongated in the second direction, of the fluid resistor layer, the first region overlapping the first channel in the plan, and
the multiple second fluid resistors are arrayed in a second region, elongated in the second direction of the fluid resistor layer, the second region overlapping the second channel in the plan.

7. The liquid discharge head according to claim 1, further comprising
a damper on a side of the sealing substrate opposite the fluid resistor layer having the first channel and the second channel.

8. The liquid discharge head according to claim 1, further comprising:
a first common liquid chamber communicating with the first channel;
a second common liquid chamber communicating with the second channel; and
a damper to define a part of a wall of the first common liquid chamber and the second common liquid chamber.

9. The liquid discharge head according to claim 1,
wherein the channel partition has a recess in a portion of the channel partition facing the first fluid resistor and the second fluid resistor in the second direction.

10. The liquid discharge head according to claim 1,
wherein the nozzle layer includes a piezoelectric body.

11. A liquid discharge apparatus comprising the liquid discharge head according to claim 1.
